(19) United States
(12) Patent Application Publication
(10) Pub. No.: US 2019/0280573 A1
(43) Pub. Date: Sep. 12, 2019

(54) METHOD OF MANUFACTURING A STATOR

(71) Applicant: GM GLOBAL TECHNOLOGY OPERATIONS LLC, Detroit, MI (US)

(72) Inventors: Jihyun Kim, Rochester Hills, MI (US); Khwaja M. Rahman, Troy, MI (US); Robert T. Dawsey, Rochester Hills, MI (US)

(21) Appl. No.: 15/913,252

(22) Filed: Mar. 6, 2018

(51) Int. Cl. H02K 15/00; H02K 1/16; H02K 3/12; H02K 3/34; H02K 3/487; H02K 15/02; H02K 15/085; H02K 15/10

(52) U.S. Cl. CPC H02K 15/0018; H02K 1/16; H02K 3/12; H02K 15/10; H02K 3/487; H02K 15/024; H02K 15/085; H02K 3/345

(57) ABSTRACT

The present disclosure provides a method for manufacturing a stator which includes the following steps: (1) providing a plurality of stator laminations; (2) stacking the plurality of stator laminations in a stator housing; (3) providing a plurality of conductors; (4) sliding at least two linear portions of each conductor into a corresponding dual position slot for the linear portion; (5) applying a jig to the plurality of dual position slots so as to close the dual position slots into a closed position. The plurality of stator laminations defining a plurality of dual position slots being in an open position when the stator laminations are stacked in the stator housing.

### TECHNICAL FIELD

The present disclosure generally relates to the field of vehicular electric motors and, more specifically, to stators with an improved conductor assembly for use in vehicular electric motors and to a method for manufacturing such stators.

### BACKGROUND

Advances in technology have led to significant changes in the design of automobiles. One of these changes involves the complexity, as well as the power usage, of various electrical systems within automobiles, particularly alternative fuel vehicles. For example, alternative fuel vehicles such as hybrid vehicles often use electrochemical power sources, such as batteries, ultracapacitors, and fuel cells, to power the electric motors (or motors) that drive the wheels, sometimes in addition to another power source, such as an internal combustion engine.

Electric motors typically include a rotor that rotates on a shaft within a stationary stator assembly. The rotor and stator assemblies each generate magnetic fields that interact with each other to cause the rotor to rotate and produce mechanical energy. The stator assembly typically includes a core having multitude of ferromagnetic annular layers (or laminations) arranged as a stack. Each lamination has several slots that, when aligned, form axial pathways that extend through the length of the core. Conductive elements such as bars, wires, or the like, typically made from copper or a copper alloy, are wound around the lamination core through these openings. Current passing through these conductors driven by a power source such as a battery or fuel cell generates electromagnetic flux that can be modulated as needed to control the speed or torque of the motor.

In a typical bar wound stator assembly, different wires or other conductors are inserted separately into each slot. The conductors are typically twisted, lined-up, and welded to form a wave winding pattern after they are inserted into the slot openings. However, this can consume result in time, cost, and effort in manufacturing the stator assembly, and/or in a stator with a larger number of welding locations than is optimal.

Accordingly, it is desirable to provide an improved stator assembly which reduces assembly time while robustly retaining the conductors/wires in the slots. It is also desirable to provide an improved method for manufacturing a stator, for example that can result in less time, cost, and/or effort. Furthermore, other desirable features and characteristics of the present invention will be apparent from the subsequent detailed description and the appended claims, taken in conjunction with the accompanying drawings and the foregoing technical field and background.

### SUMMARY

The present disclosure provides a method for manufacturing a stator which includes the following steps: (1) optionally providing a plurality of stator laminations; (2) optionally stacking the plurality of stator laminations in a stator housing; (3) providing a plurality of conductors; (4) sliding at least two linear portions of each conductor into a corresponding dual position slot in a stator having a plurality of dual position slots being in an open position; (5) applying a jig to the plurality of dual position slots so as to close the dual position slots into a closed position. The plurality of stator laminations defining a plurality of dual position slots being in an open position when the plurality of stator laminations are stacked in the stator housing.

The plurality of stator laminations defines a pair of stator tooth-tips in between each dual position slot. The pair of stator tooth-tips are in a vertical position when the linear portions of each conductor are slid into the dual position slot. However, the pair of stator tooth-tips move to a horizontal position when the jig is applied to the plurality of dual position slots. Therefore, the pair of stator tooth-tips are in the second horizontal position after the jig is applied to the plurality of dual position slots. The aforementioned method may further include the step of providing a plurality of liners configured to protect each conductor disposed within each dual position slot. Each liner may be wrapped around each conductor inserted into a slot. Alternatively, the method may include the step of inserting each liner in a dual position slot prior to sliding the at least two linear portions of each conductor into a corresponding dual position slot.

Each stator tooth-tip may define a fillet and a notch. The fillet may be defined at a distal end of the stator tooth-tip and at the interior base of the stator tooth-tip. The notch is defined at the exterior base of the stator tooth-tip so that the stator tooth-tip may easily move to the closed, horizontal position over the open slot. As indicated above, a jig is used to reconfigure the dual position slots from an open position to a closed position by pushing the stator tooth-tips from a vertical position to a closed position. The jig may come in different forms, such as but not limited to, a cylinder or a cone. In the event a cylinder is used, the cylinder wall is pressed against the vertical stator tooth-tips in a radial direction so that the stator tooth-tips are moved from the vertical, open position to the horizontal, closed position. However, in the event a cone is used, the cone may be applied to the stator by inserting the cone into the first end of the stator and pushing it to the second end of the stator. The cone's angular and straight surface regions bend the vertical stator tooth-tips to a closed, horizontal position as the cone travels from the first end of the stator to the second end of the stator.

The horizontal, closed position of the stator teeth are configured to prevent the conductor from moving out of the conductor's dedicated slot. It is understood that each stator tooth-tip undergoes plastic deformation when the stator tooth-tip is moved from the vertical open position to the closed, horizontal position.

The present disclosure also provides an electric motor having a motor housing, a stator defining a plurality of dual position slots, a rotary shaft, a rotor, and a conductor. The stator further includes a pair of foldable stator tooth-tips which are disposed between each slot. The conductor includes at two linear portions which may be disposed in at least two dual position slots. The rotor may be rotatably installed in the stator wherein the rotor includes a shaft opening so that the rotary shaft can be inserted therethrough and fixed. The stator includes a plurality of stator laminations which are stacked together. The pair of stator tooth-tips are in a vertical position when the at least two linear portions of each conductor are slid into the dual position slot. The pair of foldable stator tooth-tips between each slot are configured to move from an open, vertical position to a closed, horizontal position wherein the foldable stator tooth-tips undergo plastic deformation when the stator tooth-tips move to the closed, horizontal position. A jig may be applied to the plurality of dual position slots and their associated stator tooth-tips in a radial direction to move the stator tooth-tips from the open vertical position to the closed, horizontal position. The jig may come in a variety of forms which include, but are not limited to, a cone or a cylinder.

Each stator tooth-tip may, but not necessarily, include a fillet and a notch to facilitate moving the stator tooth-tips from the open, vertical position to the closed, horizontal position. The fillet may be defined in one or more places. For example, the fillet may be defined at a distal end of the stator tooth-tip so that the jig surface can easily slide onto the interior wall of the stator tooth-tip and close the stator tooth-tip in the correct position. The notch may be defined at a base of the stator tooth-tip wherein the notch is on the exterior wall of the stator tooth-tip. The notch is also configured to facilitate the movement of the stator tooth-tip from the open, vertical position to a closed, horizontal position over the slot.

The electric motor of the present disclosure may further include a plurality of liners wherein each liner in the plurality of liners is configured to protect each conductor disposed within each dual position slot. Each liner in the plurality of liners may be disposed between the conductor and a slot base.

The present disclosure and its particular features and advantages will become more apparent from the following detailed description considered with reference to the accompanying drawings.

### BRIEF DESCRIPTION OF THE DRAWINGS

These and other features and advantages of the present disclosure will be apparent from the following detailed description, best mode, claims, and accompanying drawings in which:

FIG. 1 is an example schematic diagram of a vehicle.

FIG. 2 is a cross-sectional view of the electric motor in FIG. 1.

FIG. 3 is a flowchart which illustrates an example, non-limiting method of the present disclosure.

FIG. 4A is a front, cross-sectional view of the stator before the conductors are installed wherein the slots are in the open position.

FIG. 4B is a front, cross-sectional view of the electric motor of FIG. 2 after the conductors are installed wherein the slots are in the closed position.

FIG. 5A is an enlarged view of the stator slots in FIG. 4A.

FIG. 5B is a view of the stator slots in FIG. 5A when the conductors are installed.

FIG. 5C is a view of the stator slots in FIG. 5B as the jig is applied to the stator tooth-tips causing the stator tooth-tips to move from the open position in FIGS. 4A-4B to the closed position (FIG. 5D.

FIG. 5D is a view of the stator slots of FIGS. 4A-4C in the closed position after the jig is applied.

FIG. 6 is an enlarged view of a second embodiment stator slot of the present disclosure.

FIG. 7A illustrates a jig in the form of a cylinder.

FIG. 7B illustrates a jig in the form of a cone.

Like reference numerals refer to like parts throughout the description of several views of the drawings.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred. Also, unless expressly stated to the contrary: percent, “parts of,” and ratio values are by weight; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, un-recited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this present disclosure pertains.

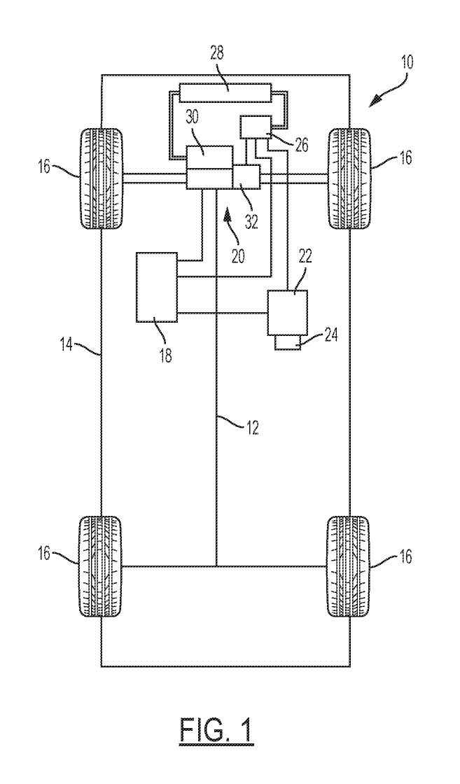

FIG. 1 is a schematic diagram of an exemplary vehicle 10, such as an automobile, according to one embodiment of the present invention. The automobile 10 includes a chassis 12, a body 14, four wheels 16, and an electronic control system (or electronic control unit (ECU)) 18. The body 14 is arranged on the chassis 12 and substantially encloses the other components of the automobile 10. The body 14 and the chassis 12 may jointly form a frame. The wheels 16 are each rotationally coupled to the chassis 12 near a respective corner of the body 14.

The automobile 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD), or all-wheel drive (AWD). The automobile 10 may also incorporate any one of, or combination of, a number of different types of engines (or actuators), such as, for example, a gasoline or diesel fueled combustion engine, a “flex fuel vehicle” (FFV) engine (i.e., using a mixture of gasoline and alcohol), a gaseous compound (e.g., hydrogen and/or natural gas) fueled engine, or a fuel cell, a combustion/electric motor hybrid engine, and an electric motor.

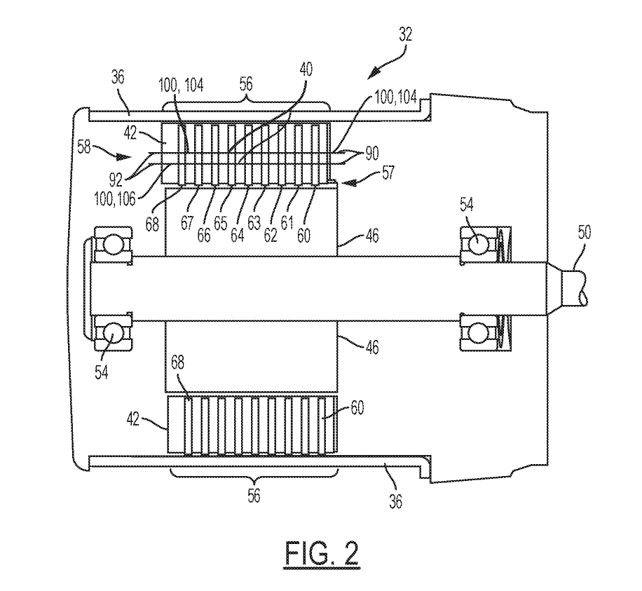

In the exemplary embodiment illustrated in FIG. 1, the automobile 10 is a hybrid vehicle, and further includes an actuator assembly (or powertrain) 20, a battery array 22, a battery state of charge (SOC) system 24, a power electronics bay (PEB) 26, and a radiator 28. The actuator assembly 20 includes an internal combustion engine 30 and an electric motor 32. The battery array 22 is electrically coupled to PEB 26 and, in one embodiment, comprises a lithium ion (Li-ion) battery including a plurality of cells, as is commonly used. Electric motor 32 typically includes a plurality of electric components, including stator and rotor assemblies. With reference to the non-limiting example shown in FIG. 2, the stator assembly 42 may include an annular core containing a multitude of annular core laminations (shown as 60-68 in FIG. 2 for example only), and a plurality of conductors (or conductive elements) extending through these laminations 60-68. At least one pair of these conductive elements is electrically isolated from adjacent conductive elements and core laminations 60-68 by an insulating layer configured in accordance with an exemplary embodiment of the invention. The insulating layer substantially circumscribes the peripheries of the pair of conductive elements and provides a continuous insulating barrier between the conductive elements and other stator core elements.

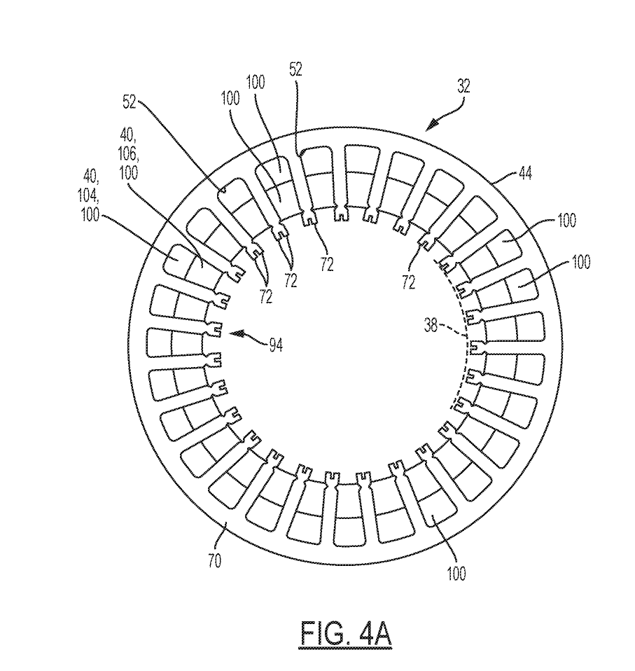

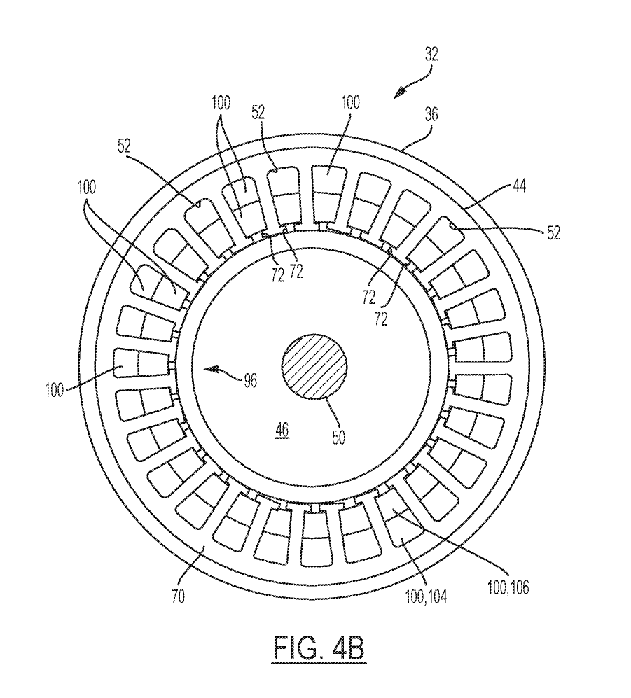

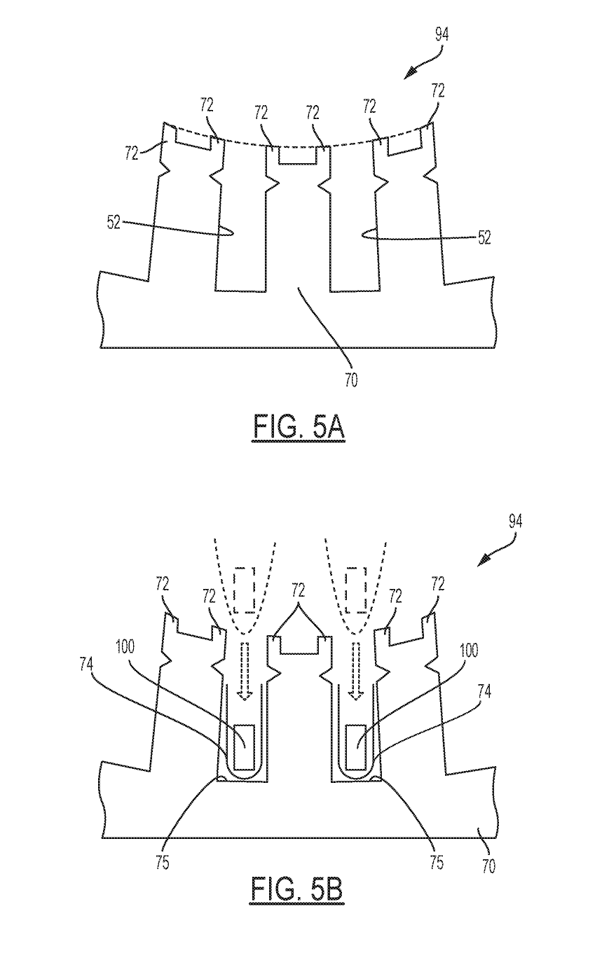

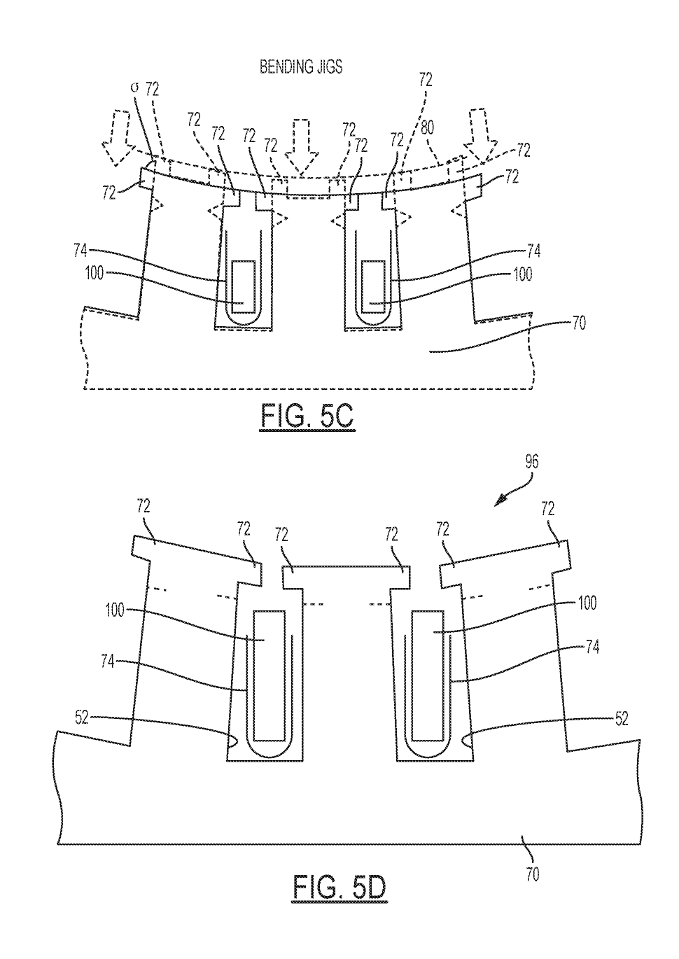

FIG. 2 is a cross-sectional side view of an electric motor 32, in accordance with an exemplary embodiment. It should be noted that many detailed elements commonly found in such an electric motor have been omitted for greater clarity. The electric motor 32 includes a housing 36, a stator assembly 42, a rotor 46, and a shaft 50. The stator assembly 42 is contained within and fixedly coupled to housing 36. The rotor 46 is fixedly coupled to shaft 50, both elements configured for rotation within stator assembly 42 about an axis of rotation A-A′. The rotor 46 is formed primarily from electrical steel. A set of bearings 54 is coupled to the housing 36 proximate either end thereof, and provide support for, and rotational coupling to, the shaft 50. The stator assembly 42 also includes a stator 56 having a first end 57 and a second end 58, and having a plurality of individual annular laminations 60-68 arranged parallel to each other in a stacked, columnar array between these ends. As shown in FIG. 4, each individual lamination is formed from electrical steel and each individual lamination has at least one dual position slot 52 (or channel) aligned with like slot 52 in each lamination throughout stator 56. The dual position slots 52 (and/or stator tooth tip 72) of the present disclosure are configured to operate in two positions: (1) open (FIGS. 4A and 5A) and (2) closed (FIGS. 4B and 5D). When the stator is completely assembled, the slots 52 of the present disclosure are in the closed position 96 (FIGS. 4B and 5D). However, as explained herein, the slots 52/stator tooth-tips 72 of the present disclosure are configured to be in the open position 94 shown in FIGS. 4A and 5A, to facilitate the manufacturing process by reducing assembly time while also providing for a robust design which retains the conductive elements in the appropriate position. This manufacturing process of the present disclosure also enables the option to pack more copper/conductor in the slot thus improving the slot-fill. Stator end-turn length can be also reduced thereby improving the packaging density of the motor.

The aligned slots of each lamination 60-68 form an axial (substantially parallel to axis of rotation A-A′) pathway through the stator 56 that may contain a different number of conductive elements (represented by a conductive element 100, 104, 106 in FIGS. 2, 4A-4B) electrically isolated from other elements within the stator 56 by an insulating layer to be described in greater detail below. The configuration of the open slots 94 prior to the insertion of the conductive element 100 is shown in FIGS. 4A and 5A. The configuration of the slots during the conductive element 100 insertion process is shown in FIG. 5B. It is understood that the conductive element(s) 100 may, but not necessarily, be manually assembled into the dual position slot(s) 52. Once the conductive elements 100 are disposed within the open slot, a bending jig 80 may be implemented to close the open slots as shown in FIG. 5C wherein the bending jig 80 applies a force to the dual position slots 52 and/or stator tooth-tips 72 shown in phantom in the radial direction as shown. It is understood that the stator tooth-tips 72 experience plastic deformation when the bending jig 80 changes the position of the slots from an open configuration 94 (shown in FIG. 5A) to a closed configuration 96 (shown in FIG. 5D). The conductive elements 100 are shown disposed within the closed slots 52 in FIGS. 4B and 5D.

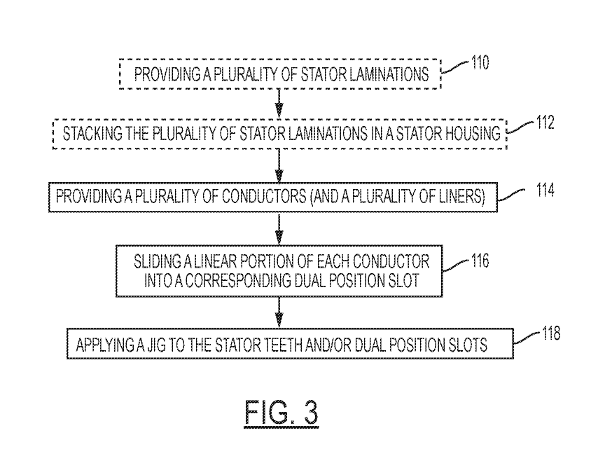

Referring now to FIG. 3, the present disclosure provides a method for manufacturing a stator which includes the following steps: (1) optionally providing a plurality of stator laminations; step 110 (2) optionally stacking the plurality of stator laminations in a stator housing; step 112 (3) providing a plurality of conductors; step 114 (4) sliding at least two linear portions of each conductor into a corresponding dual position slot for the linear portion (in a stator having dual position slots); step 116 (5) applying a jig to the plurality of dual position slots so as to close the dual position slot into a closed position. step 118 The plurality of stator laminations (shown as example elements 60-68 which form the stator core) define a plurality of dual position slots 52 being in an open position when the stator laminations 60-68 are stacked in the stator housing (prior to applying the jig to the open slots). It is understood that steps 112 and 114 may be optional wherein the stator with the dual position slots are already provided prior to the assembly process.

As shown in FIGS. 4A-5D, the plurality of stator laminations 60-68 of FIG. 2 (or stator core 70 in FIGS. 5A-5D) defines one or more stator tooth-tips 72 in between each dual position slot 52. As shown in the example of FIGS. 4A, 5A-5B, and FIG. 6, a pair of stator tooth-tips 72 are in a vertical position 94 when the linear portions 40 (FIG. 2) of each conductor 100 are slid into the dual position slot 52. Again, as shown in FIG. 2, the linear portions 40 of each conductor 100 are the sections of the conductor which are disposed between the bends 90, 92 of the conductor. The linear portions 40 of each conductor 100 are configured to be inserted within a dual position slot of the stator. FIG. 2 schematically illustrates the conductor having linear portions disposed between the bends 90, 92 of the conductor 100.

However, as shown in FIG. 5C, the pair of stator tooth-tips 72 move to a horizontal position (moving approximately by an angle θ in FIG. 5C of 70 degrees up to about 100 degrees) when the jig 80 is applied to the plurality of dual position slots 52 and/or stator tooth-tips 72. Therefore, the example pair of stator tooth-tips 72 are in the second horizontal position 96 after the jig 80 is applied to the plurality of dual position slots 52 and/or stator tooth-tips 72. With reference to FIGS. 5B-5D, the aforementioned method may further include the step of providing a plurality of slot-liners 74 configured to protect each conductor 100 disposed within each dual position slot 52. Each liner 74 may be wrapped around each conductor 100 inserted into a slot. Alternatively, the method may include the step of inserting each liner 74 in a dual position slot 52 prior to sliding the at least two linear portions 40 of each conductor 100 into corresponding dual position slots 52.

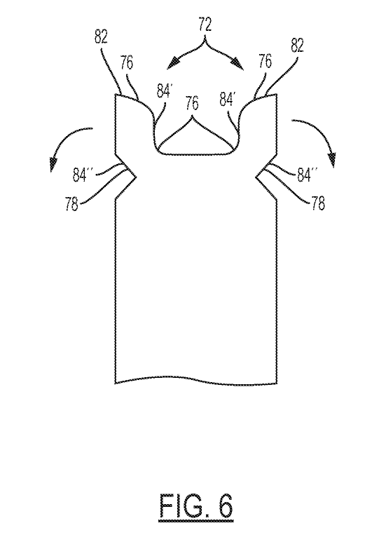

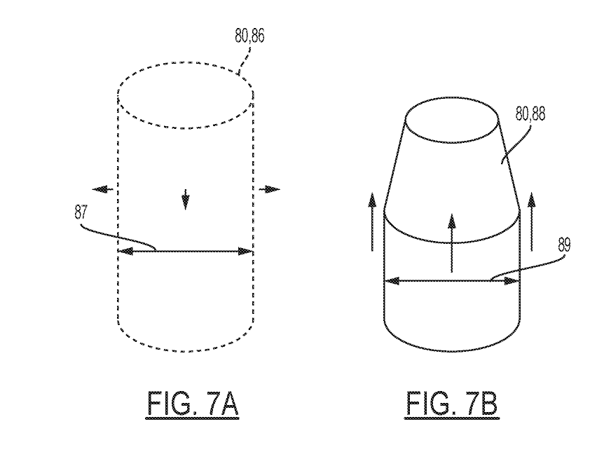

As shown in FIG. 6, each stator tooth-tip 72 may define a fillet 76 and a notch 78. The fillet 76 may be defined at a distal end 82 of the stator tooth 72 and at the interior base 84′ of the stator tooth-tips 72. As shown in FIG. 6, the notch 78 is defined at the exterior base 84″ of the stator tooth-tips 72 so that the stator tooth-tips 72 may easily move to the closed, horizontal position over the open slot. As indicated above, a jig 80 (FIG. 5C) may be used to reconfigure the dual position slots 52 from an open position 94 (FIG. 5B) to a closed position 96 (FIG. 5D) by pushing the stator teeth 72 from a vertical open position 94 to a closed horizontal position 96. The jig 80 may come in different forms, such as but not limited to, a cylinder 86 (FIG. 7A) or a cone 88 (FIG. 7B). In the event a cylinder 86 is used, the cylinder 86 wall is pressed against the vertical stator tooth-tips 72 in a radial direction so that the stator tooth-tips 72 are moved from the vertical, open position to the horizontal, closed position. However, in the event a cone 88 is used, the cone 88 may be applied to the stator by inserting the cone 88 into the first end of the stator and pushing it to the second end of the stator. The cone 88's angular and straight surface regions bend the vertical stator tooth-tips 72 to a closed, horizontal position as the cone 88 travels from the first end 57 (FIG. 2) of the stator to the second end of the stator 58 (FIG. 2). The horizontal, closed position 96 (FIG. 4B) of the stator tooth-tips 72 are configured to prevent the conductor 100 from moving out of the conductor's dedicated slot 52 in the stator. It is understood that each stator tooth-tips 72 undergoes plastic deformation when the stator tooth-tips 72 are moved from the vertical open position 94 (FIG. 5A) to the closed, horizontal position 96 (FIG. 5D).

Referring now to FIG. 2, the present disclosure also provides an electric motor having a motor housing, a stator 56 defining a plurality of dual position slots 52, a rotary shaft 50, a rotor 46, and a conductor 100. The stator 56 further includes a pair of foldable stator tooth-tips 72 which are disposed between each slot as shown in FIGS. 5A-5D. The conductor 100 includes at two linear portions 40 which may be disposed in at least two dual position slots 52 such that a linear portion 40 is inserted into a dual position slot 52 while the dual position slot 52 is in the open, vertical position 94 (FIGS. 5A-5B). It is understood that dual position slot refers to slots 52 having teeth tips which are configured to be in two different positions—open position (FIG. 4A) and closed position (FIG. 4B). The stator 56 is circumscribed about the rotor 46, and is fixedly coupled to the housing. The shaft 50 is rotationally coupled to and supported by the bearings 54 (FIG. 2). The rotor 46 rotates with the shaft 50 substantially concentrically within the stator 56. The stator 56 includes a stator core 70. The stator core 70 preferably comprises a stack lamination proximate a first end 57 thereof (FIG. 2) having a ferromagnetic annulus with inner circumferential surface 38 (FIG. 4A) substantially concentric within an outer circumferential surface 44 (FIG. 4A). The stator core 70 and/or the plurality of laminations 60-68 define a plurality of dual position slots 52, with each of the slots 52 extending generally around the inner circumferential surface 38 (FIG. 4A). With respect to the slots shown in FIGS. 4A-4B for illustrative purposes only, it is understood that, depending upon the overall design of the electric motor 32, that the stator core 70 may contain a different number of slots 52.

Referring back to FIG. 2, it is understood that during operation, current flows through the conductive element 100 of the stator 56, generating magnetic flux which interacts with flux emanating from rotor 46. The flux interaction between stator 56 and rotor 46 causes the rotor 46 to rotate with the shaft 50 about axis A-A′ thereby generating mechanical energy.

Referring now to FIG. 4B, a cross-sectional front view of the electric motor 32 is shown in accordance with an exemplary embodiment. The electric motor 32 includes the housing 36, the stator 56, the rotor 46, and the shaft 50. The stator 56 is circumscribed about the rotor 46, and is fixedly coupled to the housing 36. The shaft 50 is rotationally coupled to and supported by the bearings 54 (FIG. 2). The rotor 46 rotates with the shaft 50 substantially concentrically within the stator 56. The stator 56 includes a stator core 70. The stator core 70 preferably comprises a stack lamination proximate a first end 57 thereof (FIG. 2) having a ferromagnetic annulus within an outer circumferential surface 44. The stator core 70 and/or the stack laminations 60-68 (FIG. 2) define the plurality of dual position slots 52 wherein stator tooth-tips 72 are defined between each dual position slot 52.

In the example of FIGS. 4A and 4B, two conductive elements 100 (referenced hereafter as conductors 100) are disposed within each of the slots 52, and extend the length of stator 56 substantially axially aligned with one another. While two such conductors 100 are described and illustrated in FIG. 3 as extending through each slot 52, it is understood that each slot 52 may contain a different number of such conductors 100. Each conductor 100 may assume any form such as that of a rod, a wire, a tube, or the like, having a suitable cross-sectional shape such as, for example, substantially rectangular or circular. The conductors 100 are made of an electrically conducting material such as, for example, copper or an alloy of copper.

With reference to FIGS. 5A-5B, the pair of stator tooth-tips 72 between each slot are in a vertical open position when the each linear portion 40 of each conductor 100 is slid into the dual position slot 52. As shown, the pair of foldable stator tooth-tips 72 between each slot are configured to move from an open, vertical position 94 (FIG. 5B) to a closed, horizontal position 96 (FIG. 5D) wherein the foldable stator tooth-tips 72 undergo plastic deformation when the foldable stator tooth-tips 72 move to the closed, horizontal position. As shown in FIG. 5C, a jig 80 may be applied to the plurality of dual position slots 52 and their associated stator tooth-tips 72 in a radial direction to move the stator tooth-tips 72 from the open vertical position to the closed, horizontal position. The jig 80 may come in a variety of forms which include, but are not limited to, a cone 88 or a cylinder 86.

With reference now to FIG. 6, an enlarged view of another embodiment is shown wherein each stator tooth 72 in the electric motor may, but not necessarily, include a fillet 76 and a notch 78 to facilitate moving the stator tooth-tips 72 from the open, vertical position to the closed, horizontal position. As shown, the fillet 76 may be defined in one or more places. For example, the fillet 76 may be defined at a distal end 82 of the stator tooth 72 so that the jig 80 surface can easily slide onto the interior wall of the stator tooth-tips 72 and close the stator tooth-tips 72 in the correct position. A fillet 76 may also be defined at the interior base 84′ of each stator tooth 72 as shown in FIG. 6. The notch 78 may be defined at an exterior base 84″ of the stator tooth-tips 72. The notch 78 is configured to facilitate the movement of the stator tooth-tips 72 from the open, vertical position 94 (FIG. 5A) to a closed, horizontal position 96 (FIG. 5D) over the slot. Referring back to FIGS. 5B and 5C, the electric motor 32 of the present disclosure may further include a plurality of liners 74 wherein each liner 74 in the plurality of liners 74 is configured to protect each conductor 100 disposed within each dual position slot 52. Each liner 74 in the plurality of liners 74 may be disposed between the conductor 100 and a slot base 75 (FIG. 5B).

Conductive elements 100 (referenced hereafter as conductors 100) are disposed within each of the slots 52, and extend the length of stator 56 substantially axially aligned with one another. While such conductors 100 are described and illustrated in FIGS. 2 and 4A-B as extending through each slot 52, it is understood that each slot 52 may contain a different number of such conductors 100. Each conductor 100 may assume any form such as that of a rod, a wire, a tube, or the like, having a suitable cross-sectional shape such as, for example, substantially rectangular or circular. The conductors 100 are made of an electrically conducting material such as, for example, copper or an alloy of copper.

In a preferred embodiment, the conductors 100 may be coated with a suitable non-conducting coating to provide electrical isolation from other adjacent elements surrounding each of the conductors 100. During operation, current flows through the conductor 100 in each slot 52, generating magnetic flux thereby. Pairings of conductive elements are surrounded by an electrically insulating layer which protects each individual conductive element 100 from shorting to adjacent conductive elements and stator core surfaces. Each of the conductors 100 may also be preferably insulated and separated from one another by the liners 74. In addition, each conductor 100 may be disposed within and extends continuously through two or more slots 52 of the stator core 70.

As shown in FIGS. 4A-4B, the dual position slots 52 have two positions (open position 94 in FIG. 4A and closed position 96 in FIG. 4B). The dual position slots 52 are manufactured and configured such that the geometry of each of the slots 52 may be fully open to allow for easy insertion of pairs or groups of conductors 100 therein and be closed (FIG. 4B and FIG. 5D) to better retain the conductor 100 within each dual position slot 52. Each conductor 100 may be disposed continuously within and extends continuously through at least two of the dual position slots 52. In any case, preferably each of the conductors 100 may be a continuous conductor that is disposed within and extends continuously through two or more of the slots 52. Each conductor 100 may include an end (not shown) which is configured to be coupled to another conductor 100, preferably by twisting and welding.

Referring now to FIG. 2, each conductor 100 includes at least two linear portions 40 (FIGS. 2, 4A-4B) which extends between the bends (schematically shown as 90, 92 in FIG. 2) of the conductor 100. It is understood that the bends 90, 92 of each continuous conductor 100 may extend out of the slot 52 while the linear portions 40 between each bend 90, 92 are generally disposed in the slot 52. For example, as shown in FIG. 2, the bends 92 in the conductor 100 are exposed at the second end 58 of the slots while the bends 90 of each conductor are exposed at the first end 57 of the slots. Note, as is known in the art, it is understood that the conductor 100 used within the stator of the present disclosure is generally a continuous member which may be wound such that linear portions 40 of the conductor are the sections of the conductor 100 which are configured to be disposed within the slots 52 and the conductor may bend at each end of the slot such that the bends 90, 92 are disposed outside of the slots. As previously described, each linear portion 40 of the conductors 104, 106 may be surrounded by a liner 74 (FIGS. 5B-5C) and may be inserted into and subsequently disposed within a slot 52 of the stator core 70. For example, the conductors 104, 106 in FIG. 2 may have at least two linear portions 40 (schematically shown as element 40 in FIG. 2). The linear portions 40 of the first conductor 102 may each be surrounded by a liner 74 (FIG. 5B) and inserted into a dual position slot 52 of FIGS. 5B-5C. In addition, with respect to a second conductor 106 of FIG. 2 and FIGS. 4A-4B, each linear portion 40 of the second conductor 106 may be surrounded by a separate liner 74 (not shown) or the same liner 74 used by the first conductor 104 and inserted into dual position slot 52.

The linear portions 40 of the conductors 100 may be easily inserted into the open dual position slots 52 shown in FIGS. 4A, and 5A-5B. When the dual position slots are in the open position (FIG. 4A), more copper (conductors 100) may be inserted into in the slot (higher slot fill) and reduces the number of weldings. Elimination of the welding in the end-turn area reducing the axial packaging length of the motor thus improving motor packaging density. Again, once the linear portions 40 of the conductors 100 have been inserted within the slots 52 of the stator 56, a jig 80 shown in FIG. 5C may be used to reconfigure the open slots in the open position 94 (FIG. 5B) so that they are in the closed position 96 as shown in FIG. 5D. The jig 80 may come in various forms, such as but not limited to a cylinder 86 (FIG. 7A) and a cone (FIG. 7B). When a cylinder 86 is used as the jig 80, the cylinder 86 is exerted against the open teeth in the radial direction. The cylindrical jig 80, 86 may be implemented on the stator via a manual or automated operation. The cylindrical jig may have a diameter 87 which is less than or equal to the diameter of the inner circumferential surface 38 of the stator 56. However, when a cone 88 is used as the jig 80, the cone-like jig 80, 88 may be inserted from one end (first end 57 or second end 58) of the stator to the other end of the stator (second end 58 or first end 57 in FIG. 2) prior to assembly to the rotor 46. As the jig 80 moves through the stator 56 (cone tip leading), the cone surfaces force the stator tooth-tips from the open position to the closed position. The cone diameter 89 should be approximately equal to or less than the diameter of the inner circumferential surface 38 of the stator 56.

While multiple exemplary embodiments have been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for manufacturing a stator, the method comprising the steps of:
providing a plurality of stator laminations;
stacking the plurality of stator laminations in a stator housing, the plurality of stator laminations defining a plurality of dual position slots being in an open position;
providing a plurality of conductors, each conductor in the plurality of conductors includes at least two linear portions;
sliding the at least two linear portions of each conductor into a corresponding dual position slot for the linear portion; and
applying a jig to the plurality of dual position slots so as to close the dual position slots into a closed position.

2. The method for manufacturing a stator as defined in claim 1 wherein the plurality of stator laminations defines a pair of stator tooth-tips in between each dual position slot.

3. The method for manufacturing a stator as defined in claim 2 wherein the pair of stator tooth-tips are in a vertical position when the at least two linear portions of each conductor are slid into the dual position slot.

4. The method for manufacturing a stator as defined in claim 2 wherein the pair of stator tooth-tips are in a horizontal position after the jig is applied to the plurality of dual position slots.

5. The method for manufacturing a stator as defined in claim 2 wherein each stator tooth defines a fillet and a notch.

6. The method for manufacturing a stator as defined in claim 5 wherein the fillet is defined at a distal end of the stator tooth.

7. The method for manufacturing a stator as defined in claim 6 wherein the notch is defined at a base of the stator tooth.

8. The method for manufacturing a stator as defined 7 further comprising the step of providing a plurality of slot-liners configured to protect each conductor disposed within each dual position slot.

9. The method for manufacturing a stator as defined in claim 8 further comprising the step of inserting each slot-liner in a dual position slot prior to sliding the at least two linear portions of each conductor into a corresponding dual position slot.

10. The method for manufacturing a stator as defined in claim 7 wherein the jig is a cylinder.

11. The method for manufacturing a stator as defined in claim 7 wherein the jig is a cone.

12. An electric motor comprising:
a motor housing;
a stator defining a plurality of dual position slots wherein a pair of foldable stator tooth-tips are disposed between each slot; and
a rotary shaft;
a rotor rotatably installed in the stator, the rotor including a shaft opening so that the rotary shaft can be inserted therethrough and fixed;
a conductor disposed in the plurality of dual position slots.

13. The electric motor as defined in claim 12 wherein the stator includes a plurality of stator laminations.

14. The electric motor as defined in claim 13 wherein the pair of stator tooth-tips are in a vertical position when the at least two linear portions of each conductor are slid into the dual position slot.

15. The electric motor as defined in claim 14 wherein the pair of stator tooth-tips are in a horizontal position after a jig is applied to the plurality of dual position slots.

16. The electric motor as defined in claim 15 wherein each stator tooth-tip defines a fillet and a notch.

17. The electric motor as defined in claim 16 wherein the fillet is defined at a distal end of the stator tooth-tip.

18. The electric motor as defined in claim 17 wherein the notch is defined at a base of the stator tooth-tip.

19. The electric motor as defined in claim 18 further comprising a plurality of slot-liners configured to protect each conductor disposed within each dual position slot.

20. A method for manufacturing a stator, the method comprising the steps of:
providing a stator defining a plurality of dual position slots in an open position;
providing a plurality of conductors, each conductor in the plurality of conductors includes at least two linear portions;
sliding each of the at least two linear portions of each conductor into a corresponding dual position slot in the plurality of dual position slots; and
applying a jig to the plurality of dual position slots to close the dual position slots into a closed position.
